(19) United States
(12) Patent Application Publication
(10) Pub. No.: US 2006/0293962 A1
(43) Pub. Date: Dec. 28, 2006

(54) Computerized networking device with embedded advanced content and web traffic monetization functionality

(75) Inventors: Eugene Malobrodsky, Cupertino, CA (US); David Gorodyansky, Sunnyvale, CA (US); Igor Kaplounenko, Sunnyvale, CA (US)

Correspondence Address: SUGHRUE MION, PLLC, 401 Castro Street, Ste 220, Mountain View, CA, 94041-2007, US

(73) Assignee: ANCHORFREE, INC., Sunnyvale, CA (US)

(21) Appl. No.: 11/513,674

(22) Filed: Aug. 30, 2006

Related U.S. Application Data
(63) Continuation-in-part of application No. 11/471,247, filed on Jun. 19, 2006.
(63) Continuation-in-part of application No. 11/291,442, filed on Nov. 30, 2005.
(63) Continuation-in-part of application No. 11/291,688, filed on Nov. 30, 2005.
(63) Continuation-in-part of application No. 11/292,187, filed on Nov. 30, 2005.
(60) Provisional application No. 60/805,865, filed on Jun. 26, 2006.
(60) Provisional application No. 60/683,441, filed on May 20, 2005.

(51) Int. Cl. G06Q 30/00

(52) U.S. Cl. 705/14

(57) ABSTRACT

A networking device which may be positioned in a data stream between Internet users and Internet content providers, such that all Internet traffic between the users and the providers passes through the device. The device acts upon the passing network traffic to provide the end user with internet content/information/advertising and also redirects the http traffic from the end user using partner links of affiliated content providers such as to generate partner revenues in accordance with the affiliate ecommerce business model.

### CROSS-REFERENCE TO RELATED APPLICATIONS

This Application relies upon and claims benefit of priority of U.S. Provisional Application No. 60/805,865 filed Jun. 26, 2006, the entire disclosure of which is incorporated herein by reference. This patent application also claims benefit of and is a continuation in part of U.S. patent application Ser. No. 11/471,247, filed Jun. 19, 2006, U.S. patent application Ser. No. 11/291,442, filed Nov. 30, 2005; U.S. patent application Ser. No. 11/291,688, filed Nov. 30, 2005; and U.S. patent application Ser. No. 11/292,187, filed Nov. 30, 2005, which claims benefit of U.S. Provisional Patent Application Ser. No. 60/683,441, filed May 20, 2005; the disclosures of which are incorporated herein by reference in their entirety.

### DESCRIPTION OF THE INVENTION

1. Field of the Invention

This invention generally relates to networking technology and more specifically to techniques for enabling targeted advertising of goods and services.

2. Description of the Related Art

There exists at least several business models associated with the Internet commerce (e-commerce). Some models are simple. For example, a company may offer goods or services to customers via the web and collect revenues generated by the web sales. This model is called a generalized portal. The manufacturer or “direct model”, it is predicated on the power of the web to allow a manufacturer (i.e., a company that creates a product or service) to reach buyers directly and thereby compress the distribution channel. The manufacturer model can be based on efficiency, improved customer service, and a better understanding of customer preferences. The generated revenues are used for operating expenses of the business and to increase the capital. A good example of the generalized portal is Dell Computer corporation, which maintains a web portal www.dell.com.

In contrast to the aforesaid generalized portal model, which seeks to drive a high volume of traffic to one site, the affiliate model provides purchase opportunities wherever people may be surfing. It does this by offering financial incentives (in the form of a percentage of revenue) to affiliated partner sites. The affiliates provide purchase-point click-through to the merchant. It is a pay-for-performance model—if an affiliate does not generate sales, it represents no cost to the merchant. The affiliate model is inherently well-suited to the web, which explains its popularity. Variations include for example, banner exchange, pay-per-click, and revenue sharing programs.

The partner referral-based revenue sharing model operates in the following way. A referring website contains a link to the merchant partner website. When a user visiting a referring website uses the link to visit the merchant partner website, the referring website receives a payment from the merchant partner website in a specific fixed amount or receives a portion of the amount f money that the user spends on the merchant partner website. To enable the aforesaid revenue sharing model, the merchant partner website must be capable of distinguishing the online traffic originating from each or its partners. This is accomplished by using special partner URLs, which differ from the target website's main URL. Specifically, the aforesaid partner URL is modified in a such a way that includes the information on the referring partner website. In one example, the information identifying the partner is added to the main URL of the target website. Exemplary partner URLs include www.amazon.com/partner name.

As it is well known to persons of skill in the art, various Internet search engines derive substantial revenue from displaying advertisements to the users. Such advertisements, which are paid for by sponsors, are displayed to the users based on the keywords input by the users into the search engine as a part of the query or, alternatively, based on the content of the Internet resource (e.g. webpage) that the users view. The relevance of the displayed advertising materials to the user's preferences, interests and needs is of crucial importance and determines the value received by the advertiser from placing the ads with the search engine.

Unfortunately, the current technology limits the revenue sharing only to the web traffic originating on websites visited by the user prior to visiting the target website. Therefore it would be desirable to have a system which would expand the aforesaid revenue sharing scope to other web traffic Moreover, it would be desirable to have a system, which would enable search engines to provide more targeted advertising to the users. Finally, it would be advantageous to implement the aforesaid functionality using flexible and simple to use solution which can be deployed using a variety of hardware platforms.

### SUMMARY OF THE INVENTION

The inventive methodology is directed to methods and systems that substantially obviate one or more of the above and other problems associated with conventional techniques for data replication.

In accordance with one aspect of the inventive concept, there is provided a computerized networking apparatus including a first interface operable to establish a network connection with a client computer; a second interface operable to establish a network connection with an Internet; and a redirector module. The redirector module is configured to receive a web address information from the client computer; determine whether the received web address information is associated with a partner web service on the internet; and if the received web address information is associated with the partner web service, to redirect the client computer to the partner web service via an affiliate link.

In accordance with another aspect of the inventive concept, there is provided a computer programming product embodied on a computer-readable medium. The inventive computer programming product includes code for receiving a web address information from the client computer; and code for determining whether the received web address information is associated with a partner web service on the internet; and if the received web address information is associated with the partner web service, redirecting the client computer to the partner web service via an affiliate link.

In accordance with yet another aspect of the inventive concept, there is provided a method involving receiving a web address information from the client computer; determining whether the received web address information is associated with a partner web service on the internet; and if the received web address information is associated with the partner web service, redirecting the client computer to the partner web service via an affiliate link.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIGS. 1a and 1b illustrates one exemplary embodiment of the inventive networking device implemented as a wireless gateway.

FIGS. 2a and 2b illustrates another exemplary embodiment of the inventive networking device implemented as an in-line device.

FIG. 3 illustrates an operation of an exemplary embodiment of the networking device in accordance with the inventive concept.

FIG. 4 illustrates an exemplary frame provided by an embodiment of the inventive networking device.

FIG. 5 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

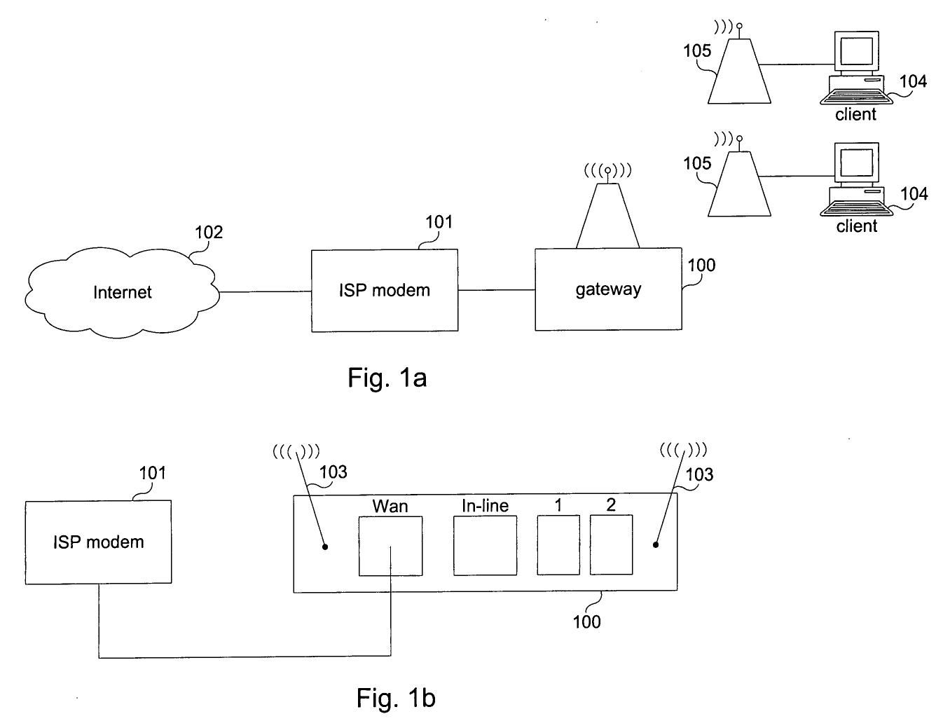

One embodiment of the inventive concept is a networking device 100 shown in FIGS. 1a and 1b which may be positioned into a data stream between Internet users and Internet content providers, such that all Internet traffic between the users and the providers passes through the inventive device 100. The device acts upon the passing network traffic to provide the end users with additional internet content/information/advertising materials and also redirects the http traffic from the end user using partner links of affiliated content providers such as to generate partner revenues in accordance with the affiliate e-commerce business model.

In one embodiment of the invention, illustrated in FIGS. 1a and 1b, the inventive embedded device is implemented as a network gateway device 100. In this implementation, the inventive device 100 incorporates embedded network gateway functionality in addition to the embedded inventive advanced advertising/information content and web traffic monetization functions. The embedded gateway device 100 may operate in accordance with either wire-based or wireless networking protocols, including, without limitation, IEEE 802.11a, IEEE 802.11b, IEEE 802.11g, and/or IEEE 802.11n, or other known or future developed networking protocols. Specifically, as shown in FIG. 1b, the inventive device 100 may be combined with a wireless gateway having one or more wireless antennas 103, which can be used as wireless hot spot end points. In one embodiment, the invention is implemented in a form of a custom firmware, which is deployed on a conventional, Linux-based network gateway device. As shown in FIG. 1a, the inventive networking device/gateway 100 is coupled to the Internet 102 using internet service provider (ISP) modem 101 and enables the clients 104 to access the Internet through the wireless networking adaptors 105.

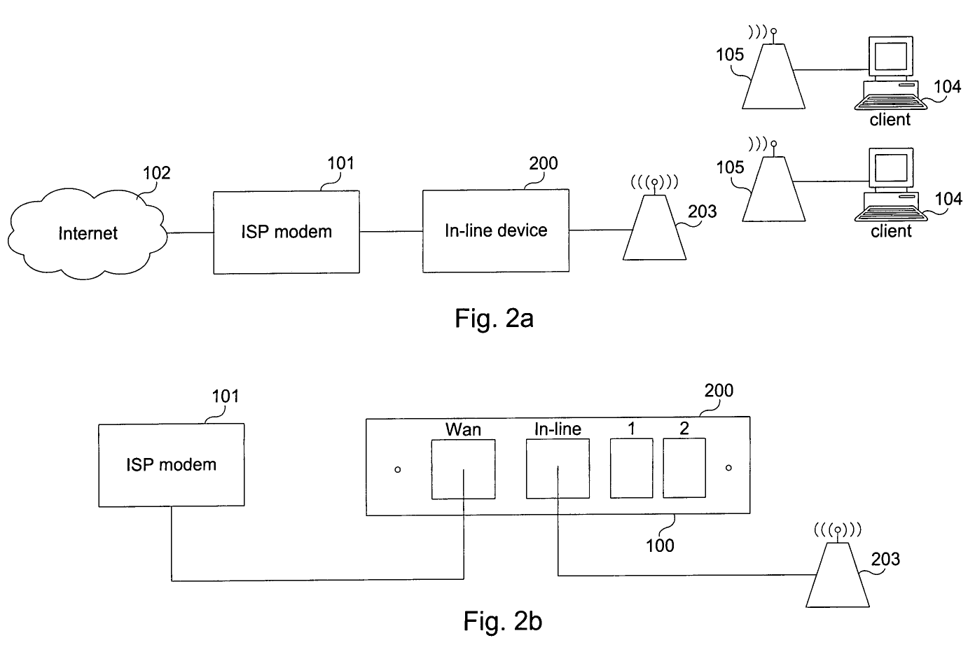

In another embodiment of the invention, shown in FIGS. 2a and 2b, the inventive embedded device is implemented as a network in-line device 200, which is preferably positioned between the ISP interface (modem) 101 and the networking gateway 203, as shown in FIGS. 2a and 2b. As one of ordinary skill in the art would appreciate, all the information received by clients 104 passes through the gateway 203, the ISP modem 101 and the in-line device 200. The in-line device 200 modifies and/or appropriately supplements this passing information, as will be described in detail below.

In another embodiment, the inventive technology is implemented as a software, which is deployed within a cellular access point or a cellular gateway to provide content to the mobile devices such as cell phones, PDA's and any other devices using CDMA or GSM technology well known to persons of ordinary skill in the art.

In yet another embodiment, the inventive technology may be implemented in a form of a programming product, such as an application program or a firmware update, which may be installed on any existing hardware networking device, such as a router, gateway, or an access point. Specifically, in one embodiment of the invention, the inventive software may be installed on any Linux-based networking devices, such as Nortel's Application Gateway 2246, known to persons of skill in the art and publicly available from Nortel Networks of Ontario, Canada.

In an embodiment of the inventive concept, the inventive embedded device provides exemplary functions, including, without limitation, insertion of internet content/information/advertising frame(s), http traffic redirection, content filtering, DHCP server/client operation and authentication mechanism enforcement. Each of these functions will be described in detail below.

Frame

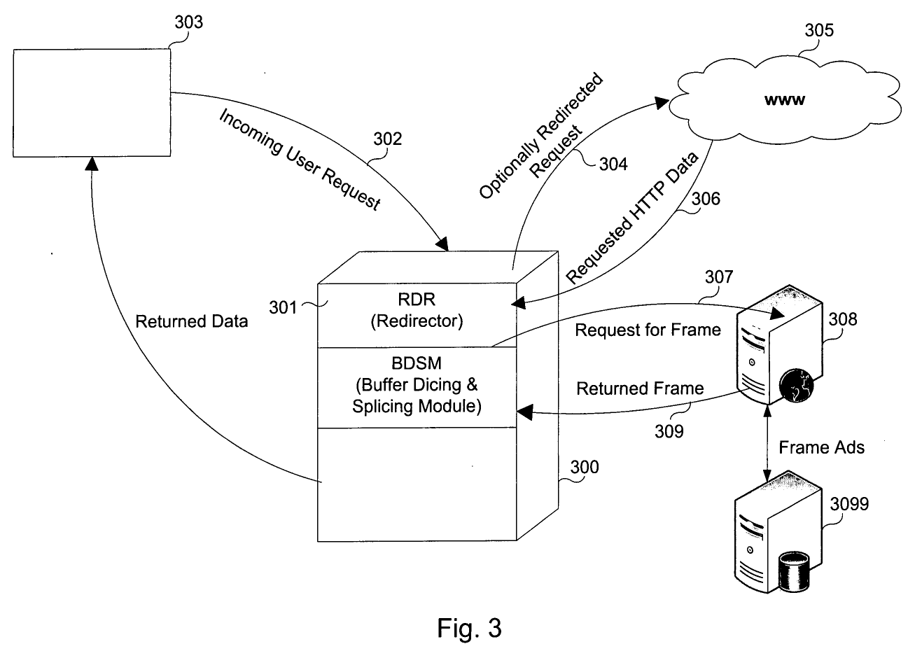

In one embodiment, the inventive device contains a proxy that buffers the web pages as well as other content that it receives from the Internet into its memory. The memory buffering unit may be implemented as a fast-access cache memory or using any other memory technology having suitable performance characteristics. The content of the memory buffer is subsequently parsed by a frame module, shown as BDSM module 311 in FIG. 3. The BDSM module 311 inserts a frame incorporating a content hosted on one of the local or remote web servers (ad servers) into the passing HTTP stream. To this end, the BDSM module 311 shown in FIG. 3 sends a request for frame 307 to the server 308. The request 307 may specify the web domain or web resource requested by the user. In response to the received request 307, the server 308 provides the frame 309 to the inventive networking device.

In one embodiment of the invention, once inserted, the frame 309 queries a content/information/advertising database to retrieve targeted content/information/advertising based on the domain information of the user or the information on the webpage requested by the user. In another embodiment the content/information/advertising materials are automatically inserted into the frame by the server 308. The server 308 may retrieve the advertising/information/content from the ad server 310.

To provide targeted ads/information/content to the user, the inventive device may store information on selecting targeted content/information/advertising materials based on the domain name requested by the user. Specifically, the device may include a database, a table, a file or a similar storage entity storing correspondence information between the requested domains and the topical information for the content/information/advertising materials shown to the user. The topical information is used, in turn, to retrieve the specific targeted advertising/information/content materials from the ad server(s) 310, see FIG. 3. In another embodiment the inventive device may simply feed the domain information to the ad server and the ad servers would provide the appropriate targeted content/information/advertising materials.

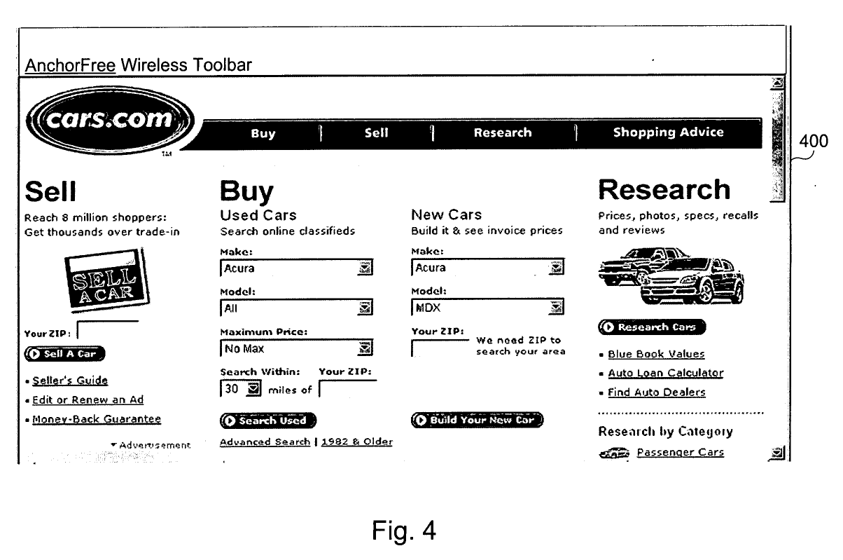

The retrieved targeted advertising/information/content information is then provided to the end user. For example, a user may request a website with a domain name www.cars.com. The inventive device would pass the domain name www.cars.com to one or more ad servers 310 and receive back the targeted advertisings/information/content that would be displayed in the frame 400 at the top of the returned web page, see FIG. 4. The device could retrieve meta tags as well as site title to include in the parsing.

Content Filter

The inventive content filer may be used to prevent certain objectionable content from being displayed to the user. The content filter may be based on a domain or web page black list, which may be updated either locally or remotely from a remote web server. In addition, the inventive system may filter each web resource for any objectionable content using known filtering techniques, such as pattern matching.

Authentication Module

The authentication module properly authenticates users who use the inventive device. This module may be implemented using the RADIUS technology well known to users of ordinary skill in the art. One example of the authentication software that can be utilized in implementing the authentication module is Chilly Spot software, which is an open source captive portal and authentication module configured to connect to the RADIUS server with appropriate login information.

Redirector

The device contains a proxy (Redirector) that redirects incoming HTTP requests for partner sites to specific URLs provided to us by these partner sites, enabling the inventive system to track user activity for purposes or awarding the users rewards for user's activities.

When a user navigates to a web resource by means of inputting a corresponding web address into a browser window or by means of clicking on a link resource in a web browser or by any other means, the user's client computer issues an HTTP request for the web resource. The inventive device intercepts this HTTP request and transforms it to redirect the user to the requested web resource through appropriate affiliate links, triggering the invocation of the affiliate payment protocol. Once the HTTP request is properly transformed, it is sent out to the recipient web resource provider.

An exemplary embodiment of the redirector module is illustrated in FIG. 3. The redirector engine 301 receives incoming HTTP requests 302 from the clients 303. The redirector engine 302 monitors the received user requests, determines if any of the user requests are directed to partner websites and, if so, redirects the matching user requests to the partner websites through appropriate affiliate links, triggering the appropriate payment routine. The redirector generated the redirected requests 304 and sends this request to the resource provider located on the Internet 305. When re-direction is complete the device no longer tracks the user. In one embodiment of the invention, the inventive device can not access secure sites such as shopping cart or banking web sites.

The Redirector 301 is located within the inventive embedded networking device 300. To this end, the content provider (not shown) may have a payment records database (also not shown), which is updated with a record specifying a payment to an affiliate, every time a user uses enters the content provider's website through the corresponding affiliate link. The content provider makes periodic payments to its affiliates based on the information stored in the payment records database.

After receiving the re-written HTTP request 304, the resource provider provides the requested HTTP data 306 back to the inventive device, which forwards it to the client 303.

In an alternative embodiment, all the payment information may be stored in the inventive networking device and provided to the affiliate merchant/content provider periodically or upon request. In this embodiment, upon determining that the user requests to access a partner website, the inventive system redirects the user to the partner website through an appropriate affiliate link and generates a billing record to be sent to the partner content provider. For this purpose, an embodiment of the inventive system 300 shown in FIG. 3 may include a payment/billing record database (not shown), which stores all such billing records. This database may be implemented as a database application executing on the user's computer or be implemented as an embedded database. In addition, the redirecting event could prompt the inventive system to record a credit to the appropriate internet service provider that hosted the requesting user. This credit information may also be stored in the aforementioned payment/billing record database.

Redirector module intercepts requests sent by the user through the inventive networking device and either simply transmits the requests without any modification or modifies the requests redirecting the user to the partner content provider through the designated affiliate links, thereby triggering the payment mechanism. To this end, the Redirector module examines the content of the user's HTTP request to determine whether the request involves one or more of the resources of an affiliate content provider. For this purpose, the Redirector module may include a database, which stores information on the identity of the affiliate content providers, as well as redirection rules. The Redirector makes queries to that database to retrieve the matching content provider information.

If the user request is not directed to the affiliated provider, as determined by the Redirector, the Redirector simply forwards the request to its intended destination. On the other hand, if the user request does contain matching partner information, the Redirector re-writes the request redirecting the user to the content provider through an appropriate affiliate link, retrieved from the aforesaid database. The redirection information may be stored in the database. When users use the inventive networking device to access participating content sites, the inventive device directs them through the partnership/affiliate link provided by the partners, thus generating revenue to the entity identified in the affiliate links utilized by the redirector module. When users go to non-participating sites the inventive device sends them through without monetizing the traffic.

Exemplary Computer Platform

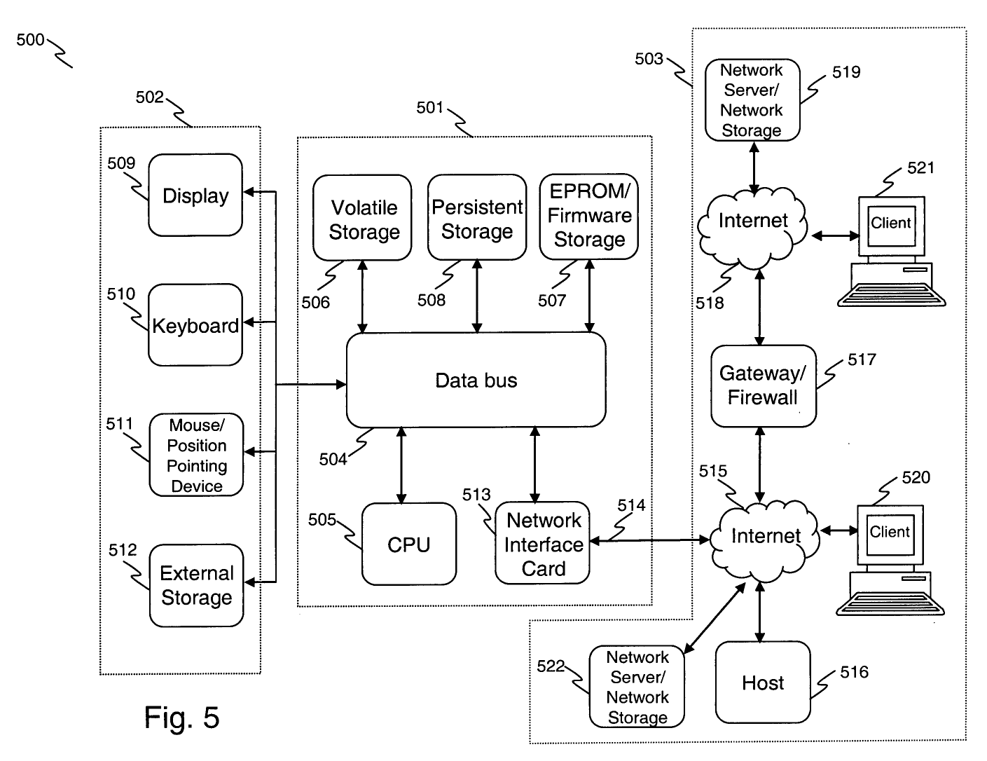

FIG. 5 is a block diagram that illustrates an embodiment of a computer/server system 500 upon which an embodiment of the inventive methodology may be implemented. The system 500 includes a computer/server platform 501, peripheral devices 502 and network resources 503.

The computer platform 501 may include a data bus 504 or other communication mechanism for communicating information across and among various parts of the computer platform 501, and a processor 505 coupled with bus 501 for processing information and performing other computational and control tasks. Computer platform 501 also includes a volatile storage 506, such as a random access memory (RAM) or other dynamic storage device, coupled to bus 504 for storing various information as well as instructions to be executed by processor 505. The volatile storage 506 also may be used for storing temporary variables or other intermediate information during execution of instructions by processor 505. Computer platform 501 may further include a read only memory (ROM or EPROM) 507 or other static storage device coupled to bus 504 for storing static information and instructions for processor 505, such as basic input-output system (BIOS), as well as various system configuration parameters. A persistent storage device 508, such as a magnetic disk, optical disk, or solid-state flash memory device is provided and coupled to bus 501 for storing information and instructions.

Computer platform 501 may be coupled via bus 504 to a display 509, such as a cathode ray tube (CRT), plasma display, or a liquid crystal display (LCD), for displaying information to a system administrator or user of the computer platform 501. An input device 510, including alphanumeric and other keys, is coupled to bus 501 for communicating information and command selections to processor 505. Another type of user input device is cursor control device 511, such as a mouse, a trackball, or cursor direction keys for communicating direction information and command selections to processor 504 and for controlling cursor movement on display 509. This input device typically has two degrees of freedom in two axes, a first axis (e.g., x) and a second axis (e.g., y), that allows the device to specify positions in a plane.

An external storage device 512 may be connected to the computer platform 501 via bus 504 to provide an extra or removable storage capacity for the computer platform 501. In an embodiment of the computer system 500, the external removable storage device 512 may be used to facilitate exchange of data with other computer systems.

The invention is related to the use of computer system 500 for implementing the techniques described herein. In an embodiment, the inventive system may reside on a machine such as computer platform 501. According to one embodiment of the invention, the techniques described herein are performed by computer system 500 in response to processor 505 executing one or more sequences of one or more instructions contained in the volatile memory 506. Such instructions may be read into volatile memory 506 from another computer-readable medium, such as persistent storage device 508. Execution of the sequences of instructions contained in the volatile memory 506 causes processor 505 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 505 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 508. Volatile media includes dynamic memory, such as volatile storage 506. Transmission media includes coaxial cables, copper wire and fiber optics, including the wires that comprise data bus 504. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 505 for execution. For example, the instructions may initially be carried on a magnetic disk from a remote computer. Alternatively, a remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on the data bus 504. The bus 504 carries the data to the volatile storage 506, from which processor 505 retrieves and executes the instructions. The instructions received by the volatile memory 506 may optionally be stored on persistent storage device 508 either before or after execution by processor 505. The instructions may also be downloaded into the computer platform 501 via Internet using a variety of network data communication protocols well known in the art.

The computer platform 501 also includes a communication interface, such as network interface card 513 coupled to the data bus 504. Communication interface 513 provides a two-way data communication coupling to a network link 514 that is connected to a local network 515. For example, communication interface 513 may be an integrated services digital network (ISDN) card or a modem to provide a data communication connection to a corresponding type of telephone line. As another example, communication interface 513 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 513 sends and receives electrical, electromagnetic or optical signals that carry digital data streams representing various types of information.

Network link 513 typically provides data communication through one or more networks to other network resources. For example, network link 514 may provide a connection through local network 515 to a host computer 516, or a network storage/server 517. Additionally or alternatively, the network link 513 may connect through gateway/firewall 517 to the wide-area or global network 518, such as an Internet. Thus, the computer platform 501 can access network resources located anywhere on the Internet 518, such as a remote network storage/server 519. On the other hand, the computer platform 501 may also be accessed by clients located anywhere on the local area network 515 and/or the Internet 518. The network clients 520 and 521 may themselves be implemented based on the computer platform similar to the platform 501.

Local network 515 and the Internet 518 both use electrical, electromagnetic or optical signals that carry digital data streams. The signals through the various networks and the signals on network link 514 and through communication interface 513, which carry the digital data to and from computer platform 501, are exemplary forms of carrier waves transporting the information.

Computer platform 501 can send messages and receive data, including program code, through the variety of network(s) including Internet 518 and LAN 515, network link 514 and communication interface 513. In the Internet example, when the system 501 acts as a network server, it might transmit a requested code or data for an application program running on client(s) 520 and/or 521 through Internet 518, gateway/firewall 517, local area network 515 and communication interface 513. Similarly, it may receive code from other network resources.

The received code may be executed by processor 505 as it is received, and/or stored in persistent or volatile storage devices 508 and 506, respectively, or other non-volatile storage for later execution. In this manner, computer system 501 may obtain application code in the form of a carrier wave.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

In addition to the networking gateway, the inventive device may be combined with a cable box, a satellite receiver or any other device operable to get content from various networks.

Moreover, other implementations of the invention will be apparent to those skilled in the art from consideration of the specification and practice of the invention disclosed herein. Various aspects and/or components of the described embodiments may be used singly or in any combination in a networking device. It is intended that the specification and examples be considered as exemplary only, with a true scope and spirit of the invention being indicated by the following claims.

What is claimed is:

1. A computerized networking apparatus comprising:
a. a first interface operable to establish a network connection with a client computer;
b. a second interface operable to establish a network connection with an Internet; and
c. a redirector module operable to:
i. receive a web address information from the client computer;
ii. determine whether the received web address information is associated with a partner web service on the internet; and
iii. if the received web address information is associated with the partner web service, to redirect the client computer to the partner web service via an affiliate link.

2. The computerized networking apparatus of claim 1, further comprising a memory buffer operable to buffer a content requested by the client computer from the internet.

3. The computerized networking apparatus of claim 2, further comprising a frame module operable to parse the information stored in the buffer memory, to insert a frame into the stored information and furnish the stored information and the inserted frame to the client computer.

4. The computerized networking apparatus of claim 3, further comprising a memory buffer interface module operable to transmit the content stored in the buffer memory to a least one network server and receive targeted content from the at least one network server, the targeted content being based on the content stored in the buffer memory.

5. The computerized networking apparatus of claim 3, wherein the frame module is operable to obtain a content of the frame from at least one network server.

6. The computerized networking apparatus of claim 5, wherein the content of the frame comprises at least one advertising object.

7. The computerized networking apparatus of claim 6, wherein the at least one network server comprises an advertising object server.

8. The computerized networking apparatus of claim 1, wherein the first interface comprises a wireless networking interface.

9. The computerized networking apparatus of claim 1, wherein the second interface comprises a wired networking interface.

10. The computerized networking apparatus of claim 1, further comprising a network gateway operable to enable the client computer to access the Internet.

11. The computerized networking apparatus of claim 1, wherein the second interface is operable to establish a network connection with the Internet via an interface service provider (ISP) modem.

12. The computerized networking apparatus of claim 1, further comprising a wireless access point operating in accordance with IEEE 802.11a, IEEE 802.11 b, IEEE 802.11g, or IEEE 802.11 n wireless access protocols.

13. The computerized networking apparatus of claim 1, further comprising a cellular access point operating in accordance with CDMA or GSM cellular protocols.

14. The computerized networking apparatus of claim 1, further comprising a content filtering module operable to prevent objectionable content from being displayed on the client computer.

15. The computerized networking apparatus of claim 1, further comprising a content filtering module operable to prevent objectionable content from being displayed on the client computer.

16. The computerized networking apparatus of claim 15, wherein the content filtering module operable to prevent objectionable content from being displayed on the client computer using at least one black list.

17. The computerized networking apparatus of claim 16, wherein the filtering module is operable to configure that black list in accordance with a command from a remote server.

18. The computerized networking apparatus of claim 1, further comprising at least one of a cable box, a satellite receiver or a device operable to obtain content from other networks.

19. The computerized networking apparatus of claim 1, further comprising an authentication module, operable to perform authentication of a user of the client computer.

20. The computerized networking apparatus of claim 19, wherein the authentication module is operable to communicate with a RADIUS server.

21. A computer programming product embodied on a computer-readable medium, comprising:
a. Code for receiving a web address information from the client computer; and
b. Code for determining whether the received web address information is associated with a partner web service on the internet;
and if the received web address information is associated with the partner web service, redirecting the client computer to the partner web service via an affiliate link.

22. The computer programming product of claim 21, further comprising code for buffering a content requested by the client computer from the internet to a memory buffer.

23. The computer programming product of claim 22, further comprising:
i. code for parsing the information stored in the buffer memory;
ii. code for inserting a frame into the stored information; and
iii. code for furnishing the stored information and the inserted frame to the client computer.

24. The computer programming product of claim 23, further comprising code for obtaining a content of the frame from at least one network server.

25. The computer programming product of claim 24, wherein the content of the frame comprises at least one advertising object.

26. The computer programming product of claim 25, wherein the at least one network server comprises an advertising object server.

27. The computer programming product of claim 21, further comprising a network gateway module operable to enable the client computer to access the Internet.

28. The computer programming product of claim 21, further comprising a filtering code for preventing objectionable content from being displayed on the client computer.

29. The computer programming product of claim 21, further comprising a authentication code for authentication of a user of the client computer.

30. A method comprising:
a. receiving a web address information from the client computer;
b. determining whether the received web address information is associated with a partner web service on the internet; and
c. if the received web address information is associated with the partner web service, redirecting the client computer to the partner web service via an affiliate link.
